(19) United States
(12) Patent Application Publication
(10) Pub. No.: US 2008/0167149 A1
(43) Pub. Date: Jul. 10, 2008

(54) Belt drive mechanism

(76) Inventors: Jean-Michel Beauprez, Menthonnex Sous Clermont (FR); Sebastien Brisson, Contamine Sur Arve (FR)

Correspondence Address: ARENT FOX LLP, 1050 CONNECTICUT AVENUE, N.W., SUITE 400, WASHINGTON, DC, 20036, US

(21) Appl. No.: 11/806,074

(22) Filed: May 29, 2007

(30) Foreign Application Priority Data
May 30, 2006 (FR) 6051953

(51) Int. Cl. F16H 57/04; F16C 13/02; B21D 39/00

(52) U.S. Cl. 474/93; 384/549; 29/428

(57) ABSTRACT

A drive mechanism mounted on a frame (10) equipped with a body (16) containing at least one inner bearing race (24) defining an axis of rotation (26), comprises a single-piece drum (48) located entirely on a first side of a radial plane of reference (34). This drum is equipped with a tread (50) that can cooperate with a drive belt, an opening in which the body is inserted, and at least one outer bearing race (54) located opposite the inner bearing race (24). A shaft (30) solidly attached to a turning element (36) extending on a second side of the geometrical plane of reference, passes through the body and is fixed to the drum by linking means (40), which extend radially between the shaft and the drum, and are tangential to a geometrical plane (62) which is perpendicular to the axis of rotation (26) and is located at a greater distance from the transversal plane of reference than the bearing races.

### TECHNICAL FIELD OF THE INVENTION

The invention relates to a belt drive mechanism and, in particular but non-limitingly, to a mechanism that can drive a paddle wheel of a water pump of a motor vehicle by means of a belt.

### PRIOR ART

Document FR 2,160,201 describes a cooling water pump for a motor vehicle. This pump comprises a paddle wheel arranged on one side of a casing element forming, on the side opposite the paddle wheel, a body that projects outwards and forms a seat for an inner bearing race. The paddle wheel is solidly attached to a shaft section that comes out of the casing at the level of the body and which is connected to a pulley rim by means of a radial arm. A outer bearing race is mounted on the rim, the inner and outer races forming a bearing located axially between the paddle wheel on the one hand and the radial connecting arm on the other hand. The arm is fixed to the shaft by welding. In this way, the pump and the casing element form a single sub-assembly. However, this sub-assembly is quite complex to assemble, since the shaft section must be welded to the arm of the pulley once the bearing has been assembled. In particular, the axial alignment between the paddle wheel and the pulley is quite difficult to respect during the assembly. Furthermore, the arm is located approximately in a median radial plane of the rim and the bearing is confined in one axial end of the rim. There is only space for a single row of balls, even when a part of the pulley is off centre. The torque resulting from the forces applied by the belt to the pulley tends to offset the pulley and, with it, the shaft section and the paddle wheel. Furthermore, the combined thickness of the pulley rim and of the outer race restricts the amount of space available for the balls of the bearing. For all these reasons, the loads that this device can support are limited.

Document EP 0,289,958 furthermore describes a cooling water pump for the engine of a motor vehicle comprising a paddle wheel installed on one side of a casing element, at the end of a shaft solidly attached to a pulley rim located on the other side of the casing element. The pulley is guided by an anti-friction bearing. The outer race of the bearing is formed directly inside the pulley rim. The inner bearing race is formed on a pin section mounted on a flange solidly attached to the pump casing. The pulley rim is located between the casing element and the flange, which increases the axial and radial size of the device. In addition, the alignment of the parts is very imperfect, which makes it necessary to take precautions regarding the gaskets between the shaft and the casing element.

### SUMMARY OF THE INVENTION

The invention therefore aims to solve the disadvantages of the prior art, with a view to providing a device that is small, easy to install, that can support a considerable load and avoids early wear and noise caused by incorrect alignment of the parts.

For this purpose, according to a first aspect of the invention, it relates to a drive mechanism comprising:
a frame equipped with a body containing at least one inner bearing race defining a geometrical axis of rotation;
a single-piece drum located entirely on one side of a geometrical plane of reference perpendicular to the geometrical axis of rotation and equipped:
   with a tread that can cooperate with a drive belt,
   with an opening in which the body is inserted, and
   with at least one outer bearing race located opposite the inner bearing race,
rolling bodies disposed on the bearing races to form a bearing;
a shaft passing through the body and solidly attached to a turning element extending on a second side of the geometrical plane; and
means for linking the shaft to the drum, extending radially between the shaft and the drum, and tangential to a geometrical plane which is perpendicular to the axis of rotation and located at a greater distance from the transversal plane of reference than the bearing races.

By means of integrating the outer bearing race in the pulley drum, it is possible to increase the distance between the bearing races, and thereby to increase the size of the rolling bodies and thus the maximum load the bearing can support. The mechanism remains compact in the axial direction, since the bearing is axially disposed between the means linking the shaft to the drum and the frame.

According to one embodiment, the linking means comprise at least one interface for assembly with the drum, located at a greater distance from the transversal plane than the bearing races. The position of the interface facilitates assembly. The distance between the assembly interface and the axis of rotation is preferably greater than the pitch diameter of the bearing. The circumference of the interface is therefore quite large, which further contributes to making assembly easier. The assembly of the bearing elements, in particular of the rolling bodies, but also when applicable of the cage and the gaskets, is also made easier.

The linking means can be assembled with the drum in various ways, in particular by crimping, bracing, welding, gluing or clamping.

In an alternative or complementary fashion to the previously described assembly interface, the linking means can comprise an interface for assembly with the shaft, located at a distance from the axis of rotation, which is smaller than the inner diameter of the body. Due to its reduced diameter, the interface for assembly with the shaft does not impede the insertion of the shaft in the body. The linking means preferably comprise a sleeve assembled with the shaft by fitting.

According to one embodiment, the linking means comprise at least one intermediate part assembled with the shaft and with the drum. The linking means preferably consist up of a cup assembled with the shaft and with the drum. This cup can advantageously be made from aluminium.

As an alternative, it is possible to provide a sub-assembly formed by the shaft and the linking means, a sub-assembly which is fixed to the drum. As an alternative, it is also possible to provide a sub-assembly that consists of the drum and linking means, which is fixed on the shaft.

The body preferably contains an inner ring on which the inner bearing race is formed. This ring can advantageously have a radial plane of symmetry, which enables it to be installed regardless of its orientation.

As an alternative, it can be provided for the inner bearing race to be formed directly on the body. It is then possible to optimise the thicknesses of the drum and of the body and, when applicable, to increase the size of the balls.

Preferably, the body has two coaxial inner bearing races and the single-piece drum is equipped with two outer bearing races located opposite the two inner bearing races, forming together with the rolling bodies a bearing with two rows of rolling bodies. In this way, the load that the mechanism can support and the power that the latter can transmit are considerably increased. Advantageously, the load lines of the rolling bodies of both rows of rolling bodies are tilted in relation to a radial plane, which grants the bearing increased axial stability.

The rolling bodies are preferably balls, although cylindrical or conical rollers or needles are also possible.

According to one particularly advantageous embodiment, it can be provided for the single-piece drum to have a radial plane of symmetry.

According to another aspect of the invention, it relates to a water pump equipped with a mechanism as described above, in which the turning element is a paddle wheel.

The turning element can, however, be any kind of receiving or driving element, the drive mechanism of the invention being capable of transmitting power equally from the belt to the shaft or from the shaft to the belt.

### BRIEF DESCRIPTION OF THE FIGURES

Further advantages and characteristics will emerge more clearly from the following description of specific embodiments of the invention, provided as non-limiting examples, and shown in the appended drawings, wherein:

FIG. 1 depicts a pulley drive mechanism according to a first embodiment of the invention, in an axial cross-section;

FIG. 2 depicts a pulley drive mechanism according to a second embodiment of the invention, in an axial cross-section;

FIG. 3 depicts a pulley drive mechanism according to a third embodiment of the invention, in an axial cross-section;

FIG. 4 depicts a pulley drive mechanism according to a fourth embodiment of the invention, in an axial cross-section;

FIG. 5 depicts a pulley drive mechanism according to a fifth embodiment of the invention, in an axial cross-section; and

FIG. 6 depicts a pulley drive mechanism according to a sixth embodiment of the invention, in an axial cross-section.

In order to simplify the presentation, the elements that are common to the various embodiments of the invention are designated by the same references and their description is not systematically repeated.

### DETAILED DESCRIPTION OF AN EMBODIMENT

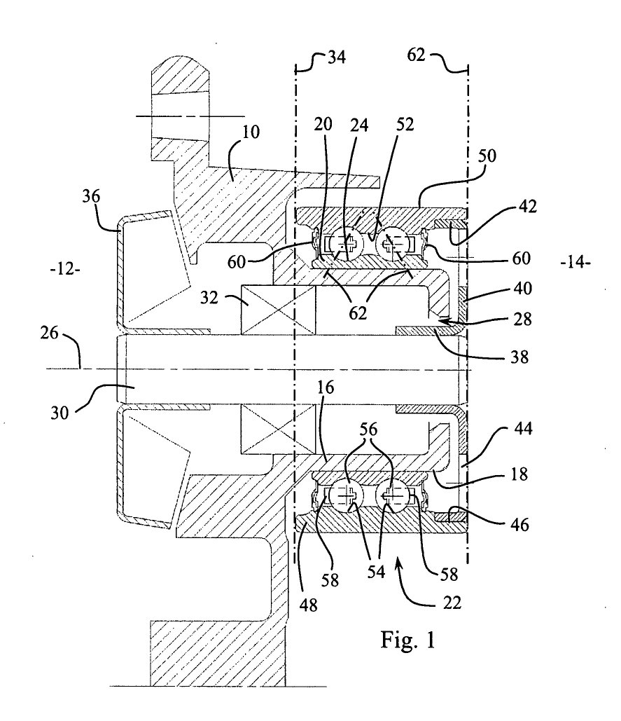

In reference to FIG. 1, a frame 10 constituting an interface between a water circuit 12 and the outside 14 is equipped with a body 16 forming a cylindrical seat 18 for an inner ring 20 of a bearing 22. The ring 20 is equipped with two bearing races 24 which define a geometrical axis of rotation 26 of the mechanism. The body 16 also delimits an axial opening 28 allowing a shaft through it 30. A dynamic seal 32 guarantees the watertightness between the shaft 30 and the frame 10, so as to avoid liquid from leaking through the opening. The frame 10 constitutes a fixed element which defines the radial geometrical plane of reference 34 crossed by the shaft 30. A paddle wheel 36 is fitted on one end of the shaft 30, on the left-hand side of the plane in the figure. A sleeve 38 of an annular cup 40, which extends radially towards the outside and is equipped with an end lip 42, is fitted on the other end of the shaft, on the right-hand side of the reference plane in the figure. The cup has openings 44 distributed across its surface. The lip 42 of the cup is fitted on an inner cylindrical seat 46 of a single-piece drum 48, so that the cup 40 constitutes a mechanical linking element between the shaft 30 and the drum 48.

The drum 48, made up of a steel part, is entirely located on the side of the reference plane 34 opposite the paddle wheel, and is equipped with a cylindrical outer surface 50 constituting a pulley tread that can cooperate with a belt (not shown). The drum 48 is hollow and its inner surface 52 delimits an opening in which the body 16 is inserted. The inner surface 52 of the drum 10 constitutes two outer bearing races 54 located opposite the bearing races 24 of the inner ring 20. These bearing races 24, 54 make it possible to install two rows of balls 56. Two cages 58 provide a separation between the balls of each row. The bearing thus formed is protected from the outside by two annular gaskets 60, mounted on the drum on either side of the bearing races 24, 54 and rubbing against the inner ring 20. The load lines 62 of the balls of the two rows are preferably tilted with regard to a radial plane, and cut the axis of rotation of the drum in two points located in two radial points framed by the bearing races.

The assembly of the mechanism in FIG. 1 is particularly straightforward. The bearing 22 made up of the inner ring 20, the drum 48, the two cages 58, the two rows of balls 56 and the two gaskets 60 is assembled in a first step. This assembly is made easier by the fact that the drum is mostly open at both ends, the seat 46 having a diameter that is greater than the pitch diameter of the two rows of balls, and even greater than the inner diameter of the bearing races. Then the inner ring 20 is fitted onto the body. Finally, the sub-assembly made up of the shaft 30 and the cup 40 is fitted onto the interface formed by the inner cylindrical seat 46 of the drum. Finally, the paddle wheel 36 is fitted onto the end of the shaft 30. As shown in the figure, the bearing races 24, 54 are located between the reference plane 34 and a radial plane 62 tangential to the cup.

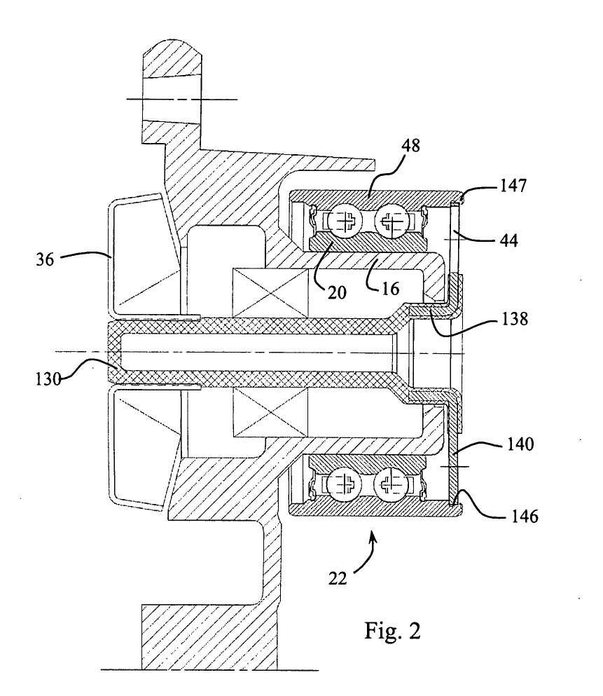

FIG. 2 shows a second embodiment of the invention, which differs from the first mode essentially by the shaft and the means for fixing the shaft to the drum. Indeed, the shaft in this case consists of a hollow part 130 made from filled polyamide 6.6, supporting the paddle wheel 36 at one end and being equipped at the other end with a sheet-metal insert 138 which projects radially outside the polyamide part towards the drum 48, forming a disc 140. The drum 48 is equipped on its inner surface with a groove 146 limited by an end lip 147. The radial periphery of the insert 140 is thus inserted by force and deforms elastically when the lip 147 passes it before assuming its position in the groove 146. The disc 140 can obviously be equipped with openings 44 to reduce the amount of material and the mass.

The assembly of the device of FIG. 2 is similar to that of the first embodiment. The first step is to assemble the bearing 22, before attaching it to the sub-assembly made up of the shaft 130 and its insert, and then the paddle wheel 36 is fixed to the free end of the shaft 130.

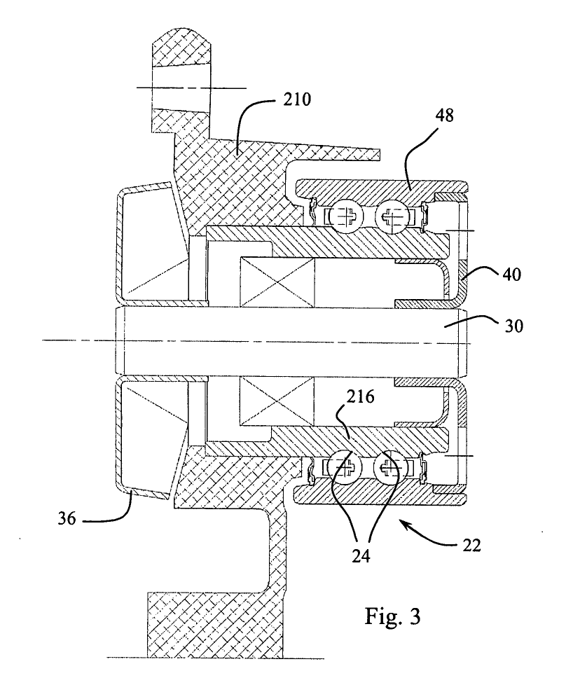

FIG. 3 shows a third embodiment of the invention. This embodiment is different from that of FIG. 1 essentially in that the inner bearing races 24 are formed integral with the body 216, which is fitted in the frame 210.

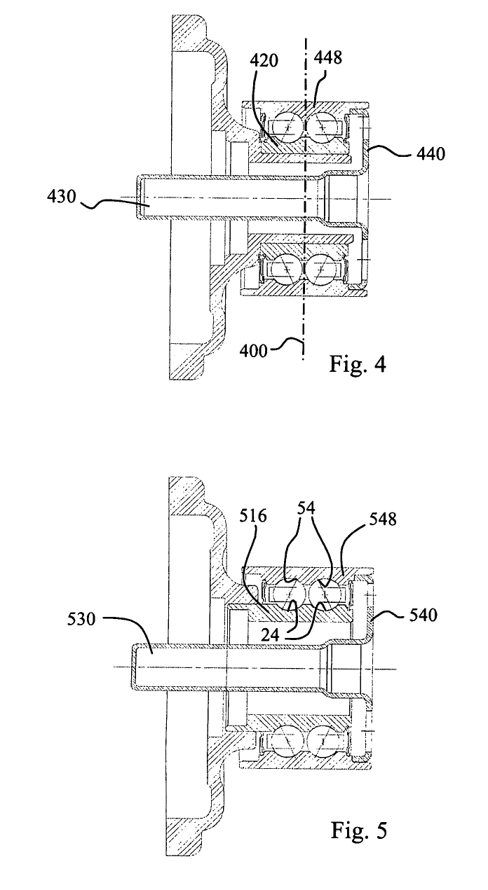

FIG. 4 shows a fourth embodiment of the invention, which is different from the preceding embodiments in that the drum 448 and the inner ring 420 are symmetrical in relation to a median radial plane 400, and in that the shaft 430 consists of a single-piece part made from pressed sheet metal, flared at one end to form a cup 440 fixed to the drum 448 in a similar manner to the first embodiment. Those skilled in the trade will clearly understand that assembly is made easier by the reduction in the number of parts and by the fact that it is no longer necessary to mark the installation direction of the bearing, enabling improved automation.

FIG. 5 shows a fifth embodiment of the invention, which combines a symmetrical drum 548 similar to that of the fourth embodiment, a body 516 integrating the bearing races 24 similar to the third embodiment, and a sub-assembly consisting of a single part of pressed-sheet metal forming the shaft 530 and a radial extension 540 for linking with the body 548, similar to the fourth embodiment of the invention. The number of parts is thus minimised.

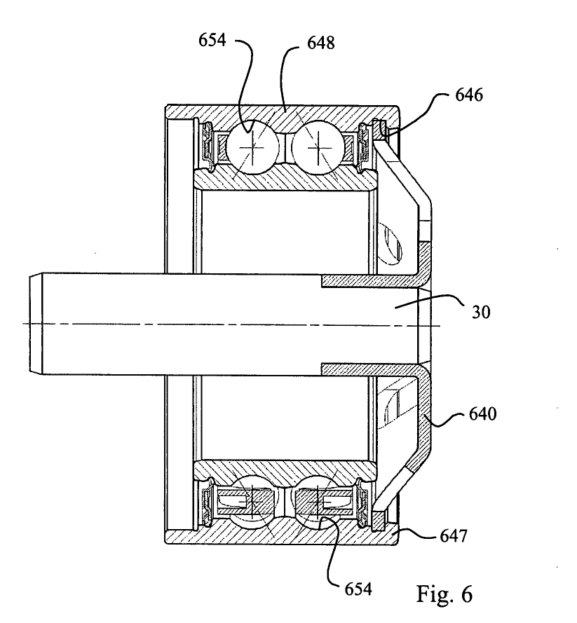

FIG. 6 shows a sixth embodiment of the invention, which is interesting in that it depicts a specific way to solidly attach the pin 30 to the body 648 by deformation of the material. A flange 640 is firstly fitted on the end of the shaft. The periphery of the flange is placed in contact with a seat 646 at the end of the drum. A tool is then used to press the lip 647 of the drum against the flange.

Naturally, various modifications are possible.

The tread can be in any shape adapted for the drive belt, for example a tapered shape or a shape with several frusta. It can, when necessary, be equipped with grooves or other raised patterns ensuring better cooperation with the belt. The term belt used throughout this application must be understood in a generic manner to include any type of endless flexible link, with any cross-section.

The invention is not limited to water pumps, as the paddle wheel can be replaced by any receiving element intended to be solidly attached with a pulley driven by a belt. The paddle wheel can also be replaced with a powered element driving the shaft and the pulley drum, and intended to drive the belt.

The linking means between the shaft and the drum can be of any type providing transmission of the torque, for example spokes or arms. The attachment elements can be rigid or can allow certain twisting elasticity.

The attachment of these linking means to the drum can be carried out by any means, in particular by crimping, shrinking on or in, gluing or welding. The attachment interface between the drum and the linking means can be smooth or equipped with raised patterns, for example flutes.

Those skilled in the trade will also know how to combine the various embodiments with one another in order to constitute other variations.

1. Drive mechanism comprising:
a frame (10) equipped with a body (16) containing at least one inner bearing race (24) defining a geometrical axis of rotation (26);
a single-piece drum (48) located entirely on one side of a geometrical plane of reference (34) perpendicular to the geometrical axis of rotation and equipped:
with a tread (50) that can cooperate with a drive belt,
with an opening in which the body is inserted, and
with at least one outer bearing race (54) located opposite the inner bearing race (24),
rolling bodies (56) disposed on the bearing races to form a bearing (22);
a shaft (30, 130, 430, 530) passing through the body and solidly attached to a turning element extending on a second side of the geometrical plane of reference; and
means (40, 140, 440, 540) for linking the shaft to the drum, extending radially between the shaft and the drum, and tangential to a geometrical plane (62) which is perpendicular to the axis of rotation (26) and located at a greater distance from the transversal plane of reference than the bearing races.

2. Drive mechanism according to claim 1, wherein the linking means comprise at least one interface (46) for assembly with the drum, located at a greater distance from the transversal plane of reference than the bearing races.

3. Mechanism according to claim 2, wherein the distance between the assembly interface and the axis of rotation is greater than the pitch diameter of the bearing.

4. Drive mechanism according to claim 2, wherein the linking means are attached to the drum by crimping, bracing, welding, gluing or clamping.

5. Drive mechanism according to claim 2, wherein the linking means further comprise at least one interface (28, 138) for assembly with the shaft, located at a distance from the axis of rotation, which is smaller than the inner diameter of the body.

6. Mechanism according to claim 5, wherein the linking means preferably comprise a sleeve (38) assembled with the shaft by fitting.

7. Mechanism according to claim 1, wherein the linking means comprise at least one intermediate part (40) assembled with the shaft and with the drum.

8. Mechanism according to claim 7, wherein the linking means consist of a cup (40) assembled with the shaft and with the drum.

9. Mechanism according to claim 1, wherein the body preferably contains an inner ring (20) on which the inner bearing race is formed.

10. Mechanism according to claim 9, wherein the inner ring has a median radial plane of symmetry (400).

11. Mechanism according to claim 1, wherein the inner bearing race is formed directly on the body.

12. Drive mechanism according to claim 1, wherein the body has two coaxial inner bearing races (24) and the single-piece drum is equipped with two outer bearing races (54) located opposite the two inner bearing races, forming together with the rolling bodies a bearing (22) with two rows of rolling bodies.

13. Drive mechanism according to claim 12, wherein the load lines (62) of the rolling bodies of the two rows of rolling bodies are tilted in relation to the reference plane.

14. Mechanism according to claim 1, wherein the rolling bodies are balls (56).

15. Mechanism according to claim 1, wherein the single-piece drum has a median radial plane of symmetry (400).

16. Mechanism according to claim 1, wherein the drum consists of a steel part (48).

17. Water pump of a motor vehicle, equipped with a drive mechanism according to claim 1, the turning element consisting of a paddle wheel (36).

18. Drive mechanism according to claim 3, wherein the linking means are attached to the drum by crimping, bracing, welding, gluing or clamping.

19. Drive mechanism according to claim 18, wherein the linking means further comprise at least one interface (28, 138) for assembly with the shaft, located at a distance from the axis if rotation, which is smaller than the inner diameter of the body.
